(19) United States
(12) Patent Application Publication
(10) Pub. No.: US 2026/0249822 A1
(43) Pub. Date: Aug. 27, 2026

(54) BRAKING FEEL SIMULATOR DEVICE

(71) Applicant: BREMBO S.p.A., Curno (Bergamo) (IT)

(72) Inventors: Andrea MILANESI, Curno (Bergamo) (IT); Martina TRUFFELLO, Curno (Bergamo) (IT)

(73) Assignee: BREMBO S.p.A., Curno (Bergamo) (IT)

(21) Appl. No.: 18/994,114

(22) PCT Filed: Jun. 23, 2023
(86) PCT No.: PCT/IB2023/056509

§ 371 Date: Jan. 14, 2025

(30) Foreign Application Priority Data
Jul. 15, 2022 (IT) 102022000014866

(51) Int. Cl. B60T 8/40; B60T 7/04; B60T 8/171; B60T 8/172

(52) U.S. Cl. CPC B60T 8/409; B60T 7/042; B60T 8/171; B60T 8/172; B60T 2220/04; B60T 2270/82

(57) ABSTRACT

A braking system has a feel simulator device adapted to be connected to a brake pedal, the braking feel simulator device having a reservoir configured to contain a hydraulic fluid, and an absorber configured to apply a reaction force on the brake pedal against an actuation of the brake pedal. The reservoir and the absorber are directly fluidically connected to each other by a first hydraulic duct. The first hydraulic duct has a calibrated orifice interposed between the reservoir and the absorber.

### FIELD OF THE INVENTION

The present invention relates to a braking feel simulator device for a Brake-By-Wire (“BBW”) type braking system of vehicles with two or more wheels actuatable by a driver by means of a brake pedal or lever, and a braking system provided with such a braking feel simulator device.

### BACKGROUND ART

In braking systems of the BBW type, there is a decoupling between force and displacement imparted on the brake pedal or lever by the driver and the resulting braking force which is applied by the calipers to the vehicle wheels.

In BBW braking systems, the force and displacement imparted by the driver on the brake pedal or lever are transduced into an electrical signal which is processed by a control unit to control the actuation of the braking system calipers.

Accordingly, it is known to equip the BBW braking systems with a braking feel simulator device connected to the brake pedal or lever and configured to simulate the feel and stiffness of a brake pedal or lever of conventional hydraulic braking systems, and thus emulate the “stiffness curve” thereof.

“Stiffness curve” means the relationship between the displacement of the brake pedal or lever along its stroke and the respective reaction force applied by the simulator device on the brake pedal or lever, and thus by the brake pedal or lever on the driver.

Driving safety and comfort strictly depend on the stiffness of the brake pedal or lever, implemented by the braking feel simulation devices.

Braking feel simulator devices comprising a master cylinder connected to the brake pedal are known.

The master cylinder comprises a float, which is moved by the driver's mechanical action on the brake pedal and has the function of pressurizing the hydraulic fluid.

The hydraulic fluid is contained in a reservoir fluidically connected to the master cylinder by means of a hydraulic connection.

Moreover, the master cylinder is fluidically connected by means of an additional hydraulic connection to an absorber, which is a device generally provided with a plurality of elastic elements arranged in series and in parallel, configured to apply an elastic reaction force against a brake pedal actuation.

In such known simulator devices, the connection between the master cylinder and the absorber comprises a calibrated orifice.

The calibrated orifice is configured to implement a damping force against the brake pedal actuation.

The absorber and the calibrated orifice interposed between the master cylinder and the absorber are responsible for the generation of the reaction force in response to a brake pedal actuation, which emulates the stiffness curve of a conventional braking system.

However, such known simulator devices have a large volume which make them difficult to install inside the passenger compartment of the vehicle, in which there is less space available, in both the hanging brake pedal configuration and the floor brake pedal configuration. Due to the large volume, the known simulator devices are generally installed in the engine compartment of the vehicle, under the hood.

Moreover, the actuation of such known simulator devices has an initial idle stroke during which no reaction force is applied on the brake pedal by the simulator device, which adversely affects the braking and driving feel perceived by the driver.

The need is felt to reduce the idle stroke of the simulator device as much as possible, and thus that a brake pedal movement immediately corresponds to the reaction force by the simulator device.

In known simulator devices, the idle stroke is inherent to the master cylinder, because the actuation of the master cylinder requires an initial movement of the float to plug a compensation hole of the master cylinder and initiate the pressurization of the hydraulic fluid.

Moreover, the known simulator devices exhibit high tolerances related to the stiffness curve they generate. The high tolerances, which are to be reduced as much as possible, are mainly due to the large number of components forming the known simulator devices, the individual tolerances of which, combined together, result in a high tolerance in generating the stiffness curve.

The high number of components also adversely affects the cost and maintenance requirements of the known simulator devices.

A further critical issue with known simulator devices concerns the real and perceived safety of the driver due to the presence of pressurized components inside the passenger compartment, such as a possible installation of the master cylinder of the simulator device close to the driver. Indeed, it is necessary to maintain a constant pressure of about 50 bar inside the master cylinder to ensure the braking action.

### SOLUTION

It is the object of the present invention to provide a braking feel simulator device and a braking system provided with such a simulator device, such as to obviate at least some of the drawbacks of the prior art.

It is a particular object of the present invention to provide a more compact braking feel simulator device adapted to be installed inside the vehicle passenger compartment, in both the hanging brake pedal configuration and the floor brake pedal configuration.

It is a further particular object of the present invention to provide a braking feel simulator device in which the idle stroke is minimized.

It is further particular object of the present invention to provide a braking feel simulator device and a braking system provided with such a simulator device, which exhibit reduced tolerances in the generation of the stiffness curve.

It is a further particular object of the present invention to provide a braking feel simulator device and a braking system provided with such a simulator device, which have low costs and lower maintenance requirements.

It is a further particular object of the present invention to provide a braking feel simulator device and a braking system provided with such a simulator device, which exhibit a greater safety both real and perceived by the driver.

These and other objects are achieved by a braking feel simulator device and a braking system provided with such a simulator device according to the independent claims.

The dependent claims relate to preferred and advantageous embodiments of the present invention.

### FIGURES

In order to better understand the invention and appreciate the advantages thereof, some non-limiting exemplary embodiments thereof will be described below with reference to the accompanying drawings, in which:

FIG. 1 diagrammatically shows a braking system comprising a braking feel simulator device, according to the prior art;

FIG. 2 diagrammatically shows a braking system comprising a braking feel simulator device, according to an embodiment of the invention;

FIG. 3 diagrammatically shows a braking system comprising a braking feel simulator device, according to a further embodiment of the invention;

FIG. 4 is a front perspective view of a braking feel simulator device according to an embodiment of the invention;

FIG. 5 is a rear perspective view of the braking feel simulator device shown in FIG. 4;

FIG. 6 is a side view of the braking feel simulator device shown in FIG. 4;

FIG. 7 is a longitudinal section view of the braking feel simulator device shown in FIG. 4;

FIG. 8 is an exploded front perspective view of the braking feel simulator device shown in FIG. 4;

FIG. 9 is an exploded rear perspective view of the braking feel simulator device shown in FIG. 4;

FIG. 10 is a front perspective view of a braking feel simulator device according to an embodiment of the invention;

FIG. 11 is a rear perspective view of the braking feel simulator device shown in FIG. 10;

FIG. 12 is a side view of the braking feel simulator device shown in FIG. 10;

FIG. 13 is a longitudinal section view of the braking feel simulator device shown in FIG. 10;

FIG. 14 is an exploded front perspective view of the braking feel simulator device shown in FIG. 10;

FIG. 15 is an exploded rear perspective view of the braking feel simulator device shown in FIG. 10;

FIG. 16 is a top view of the braking feel simulator device shown in FIG. 10;

FIG. 17 is a cross-section view of the braking feel simulator device shown in FIG. 16.

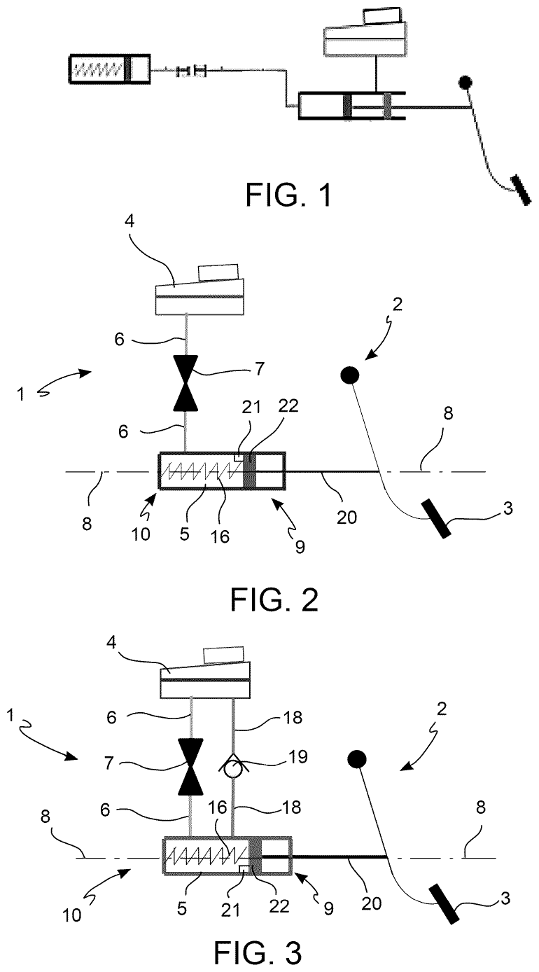

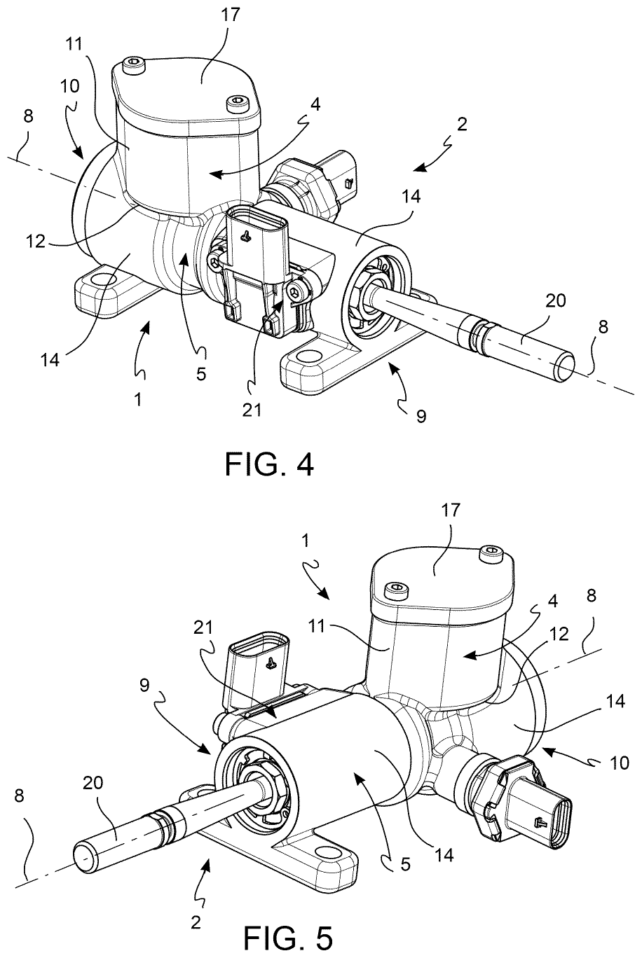

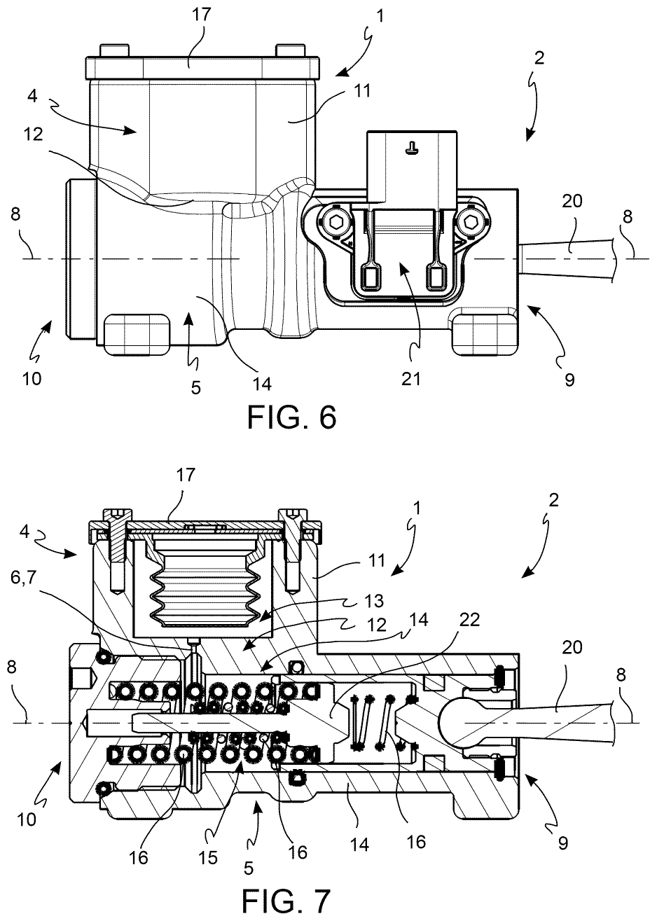

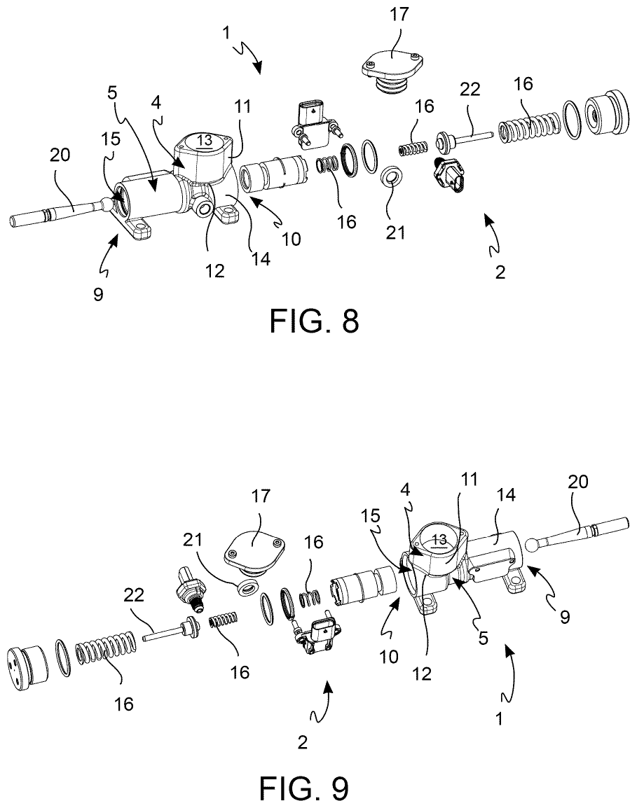

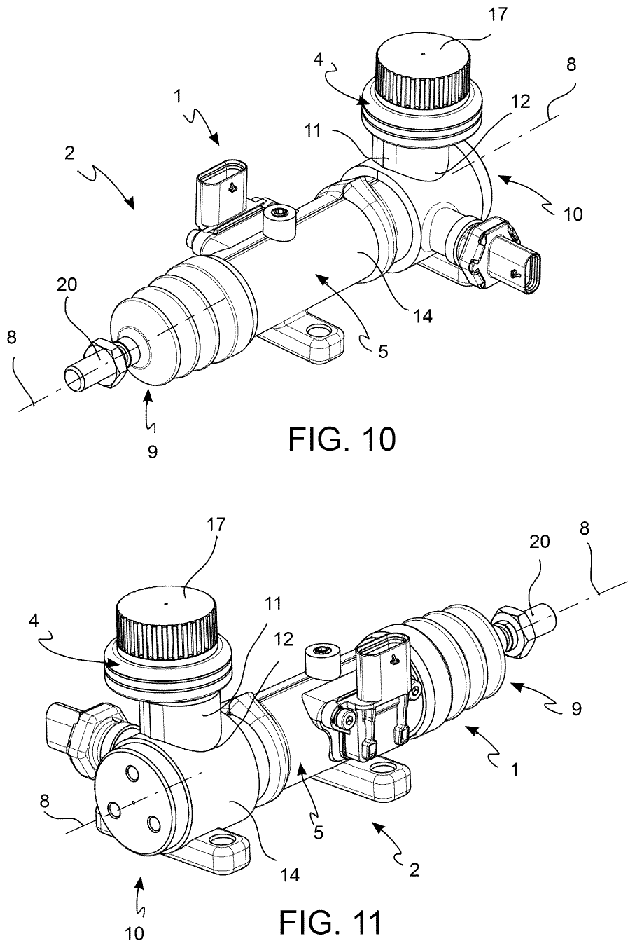

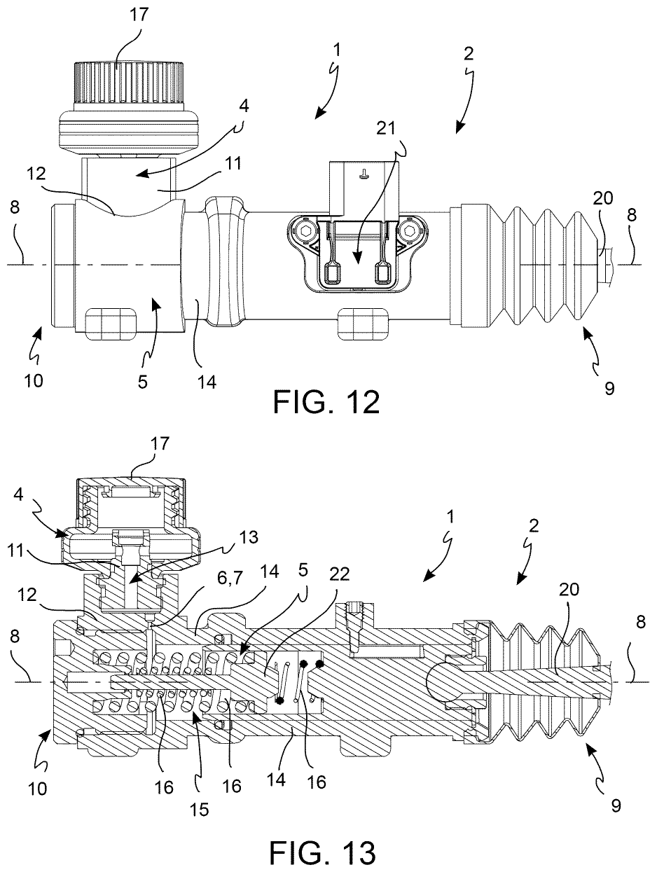

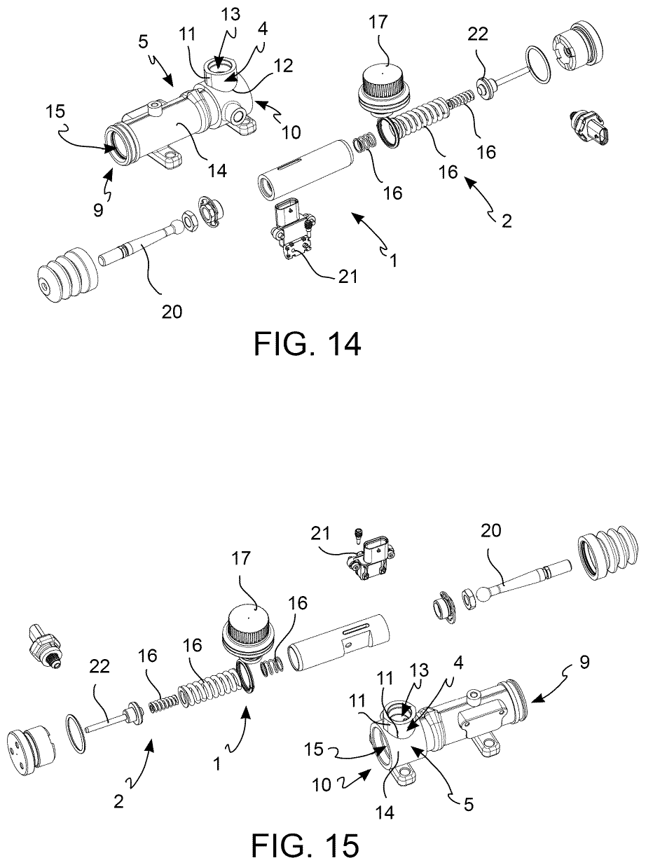

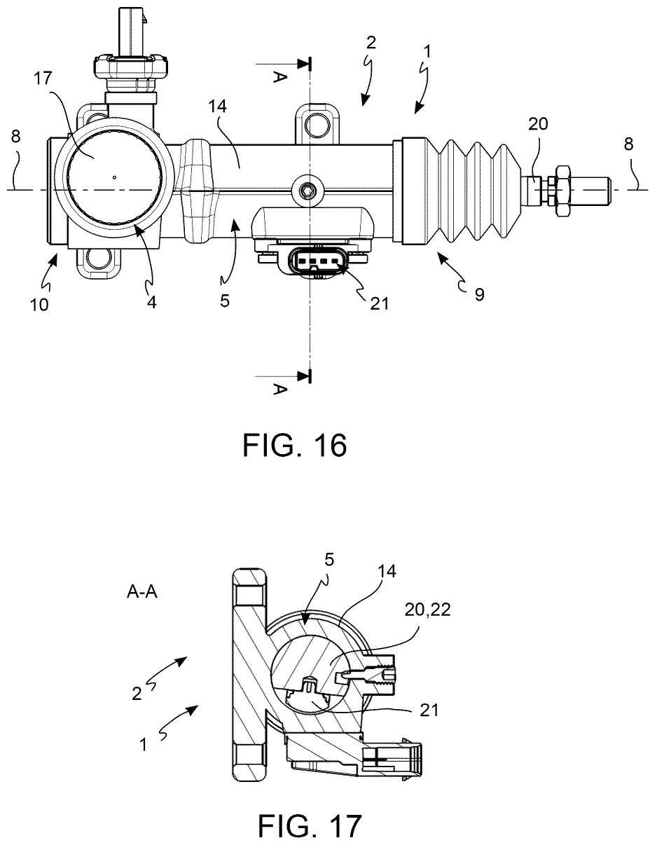

### DESCRIPTION OF SOME PREFERRED EMBODIMENTS

The present invention is suitable for being applied to a Brake-By-Wire (“BBW”) type braking system of vehicles with two or more wheels, which is actuatable by a driver by means of a brake pedal or lever. Therefore, in the present description, the term “brake pedal” means indistinctly both a brake pedal for motor vehicles and the like and a brake lever for motorcycles, mopeds, and the like, unless otherwise specified.

With reference to the figures, a braking feel simulator device is generally indicated by reference numeral 1. The braking feel simulator device 1 is adapted to be used in a braking system 2.

The braking feel simulator device 1 is adapted to be connected to a brake pedal 3.

The braking feel simulator device 1 comprises a reservoir 4 and an absorber 5.

The reservoir 4 is configured to contain hydraulic fluid.

The absorber 5 is configured to apply a reaction force on the brake pedal 3 against an actuation of the brake pedal 3.

The absorber 5 is configured to contain hydraulic fluid.

According to an aspect of the invention, the reservoir 4 and the absorber 5 are directly fluidically connected to each other by means of a first hydraulic duct 6.

Moreover, the first hydraulic duct 6 comprises a calibrated orifice 7 interposed between the reservoir 4 and the absorber 5.

Specifically, the calibrated orifice 7 is configured to dampen a flow of hydraulic fluid passing between the absorber 5 and the reservoir 4.

Advantageously, an actuation of the braking feel simulator device 1 thus configured, in response to an actuation of the brake pedal 3, conveys a flow of hydraulic fluid from the absorber 5 to the reservoir 4, which is damped by the calibrated orifice 7.

Such a damping, in combination with the counteracting action of the absorber 5, implements the reaction force in response to an actuation of the brake pedal 3, which emulates the stiffness curve of a conventional braking system.

Advantageously, a braking feel simulator device 1 thus configured is more compact than the simulator devices of the prior art and is adapted to be installed inside the passenger compartment of the vehicle, in both the hanging brake pedal configuration and the floor brake pedal configuration.

Indeed, the braking feel simulator device 1 thus configured lacks a master cylinder interposed between the reservoir 4 and the absorber 5, and thus has smaller overall size and volume.

Specifically, the braking feel simulator device 1 thus configured has no hydraulic machines interposed between the reservoir 4 and the absorber 5.

With added advantage, a braking feel simulator device 1 thus configured minimizes the idle stroke of the braking feel simulator device 1.

Indeed, since the braking feel simulator device 1 lacks a master cylinder interposed between the reservoir 4 and the absorber 5, an actuation of the brake pedal 3 corresponds to an immediate actuation of the absorber 5.

With added advantage, a braking feel simulator device 1 thus configured exhibits lower tolerances in the generation of the stiffness curve, because the inherent tolerances of a master cylinder, which is absent in the braking feel simulator device 1 thus configured, are canceled.

With added advantage, a braking feel simulator device 1 thus configured is simplified compared to the prior art because it lacks a master cylinder. Such a simplification results in low costs and lower maintenance requirements.

With added advantage, a braking feel simulator device 1 thus configured exhibits a greater safety both real and perceived by the driver.

Indeed, devices constantly subjected to high pressures, which would also require high sizing, are not present in the braking feel simulator device 1.

Conversely, the braking feel simulator device 1 is only subjected to a small transient pressure peak when the hydraulic fluid starts flowing from the absorber 5 to the reservoir 4.

The braking feel simulator device 1 is configured to contain hydraulic fluid, with fluid continuity, inside the absorber 5 and the reservoir 4.

According to an embodiment, the braking feel simulator device 1 comprises hydraulic fluid contained, with fluid continuity, inside the absorber 5 and the reservoir 4.

Therefore, in an operating configuration, the hydraulic fluid fills the absorber 5, the first hydraulic duct 6, and at least partially the reservoir 4.

Advantageously, the braking feel simulator device 1 thus configured, with the absorber 5 in the hydraulic fluid bath, minimizes the idle stroke of the braking feel simulator device 1.

According to an embodiment of the invention, the absorber 5 extends along an actuation axis 8, between a first absorber end 9 and an opposite second absorber end 10.

According to an embodiment, the first hydraulic duct 6 extends along a direction substantially transverse to the actuation axis 8.

Advantageously, such a configuration reduces the overall volume of the braking feel simulator device 1.

According to an embodiment, the absorber 5 is configured to be connectable to the brake pedal 3.

Preferably, the absorber 5 is configured to be connectable to the brake pedal 3 at the first absorber end 9.

Moreover, the absorber 5 is configured to be actuatable by the brake pedal 3 at the first absorber end 9.

According to an embodiment, the absorber 5 is configured so that an actuation of the brake pedal 3 corresponds to a pressurization of the hydraulic fluid contained in the absorber 5, which conveys a flow of hydraulic fluid from the absorber 5 to the reservoir 4, through the first hydraulic duct 6.

According to an embodiment, the absorber 5 comprises a perimeter wall 14 substantially extending in a direction parallel to the actuation axis 8, between the first absorber end 9 and the second absorber end 10.

The perimeter wall 14 defines a housing compartment 15 therein, configured to contain the hydraulic fluid.

According to an embodiment, the reservoir 4 comprises a containing wall 11 and a bottom wall 12.

The bottom wall 12 is substantially transverse to the containing wall 11.

The bottom wall 12 and the containing wall 11 form a reservoir compartment 13 configured to contain the hydraulic fluid.

According to an embodiment, the containing wall 11 forms a top-up opening. Preferably, the top-up opening is positioned opposite to the bottom wall 12.

The top-up opening is configured to allow topping up hydraulic fluid in the reservoir 4.

The top-up opening is closable by means of a cap 17.

According to an embodiment, the first hydraulic duct 6 extends through the bottom wall 12 of the reservoir 4 and the perimeter wall 14 of the absorber 5.

The first hydraulic duct 6 thus fluidically connects the reservoir compartment 13 to the housing compartment 15.

Advantageously, such a configuration reduces the overall volume of the braking feel simulator device 1.

According to an embodiment, the reservoir 4 is fixed to the absorber 5.

According to an embodiment, the reservoir 4 is made in one piece with the absorber 5.

According to an embodiment, the bottom wall 12 extends in a plane substantially parallel to the actuation axis 8 and the containment wall 11 is substantially transverse to the actuation axis 8.

According to an embodiment, the bottom wall 12 of the reservoir 4 substantially coincides with a portion of the perimeter wall 14 of the absorber 5.

According to an embodiment, the reservoir 4 is at least partially interpenetrated with the absorber 5.

According to an embodiment, the bottom wall 12 of the reservoir 4 is at least partially interpenetrated with the perimeter wall 14 of the absorber 5.

According to an alternative embodiment, the reservoir 4 is distinct from the absorber 5. The fluid connection between the reservoir 4 and the absorber 5 is ensured by the first hydraulic duct 6.

Advantageously, the reservoir 4 thus configured is freely positionable and orientable with respect to the absorber 5.

According to an embodiment, the first hydraulic duct comprises a flexible pipe, extending between the reservoir 4 and the absorber 5.

According to an embodiment, the calibrated orifice 7 is configured to generate the damping required by a driver.

According to an embodiment, the calibrated orifice 7 forms a section having a diameter between 0.7 mm and 1.5 mm.

According to an embodiment, the calibrated orifice 7 has a length less than 3.0 mm.

According to an embodiment, the first hydraulic duct 6 has a length less than 10.0 mm.

According to this embodiment, the distance between the reservoir compartment 13 and the housing compartment 15 is less than 3.0 mm.

According to an embodiment, the first hydraulic duct 6 has a length less than 3.0 mm.

According to this embodiment, the distance between the reservoir compartment 13 and the housing compartment 15 is less than 3.0 mm.

According to an embodiment, the absorber 5 comprises at least one elastic element 16 positioned inside the housing compartment 15.

The at least one elastic element 16 is configured to apply a reaction force in response to an actuation of the braking feel simulator device 1. Specifically, the at least one elastic element 16 is configured to apply a reaction force on the brake pedal 3 in response to an actuation of the brake pedal 3 by a driver.

The at least one elastic element 16 is configured to be biased along a direction substantially parallel to the actuation axis 8.

According to an embodiment, the absorber 5 comprises a plurality of elastic elements 16 positioned in series and/or in parallel within the housing compartment 15.

According to an embodiment, the elastic elements 16 comprise a plurality of compression coil springs positioned substantially coaxial to the actuation axis 8.

According to an embodiment, the elastic elements 16 comprise conical spring washer and/or square springs and/or torsion springs and/or strip springs and/or shaped springs.

According to an embodiment, in the operating configuration, the at least one elastic element 16 is immersed in the hydraulic fluid.

Preferably, the plurality of compression coil springs positioned substantially coaxial to the actuation axis 8 is immersed in the hydraulic fluid.

According to an embodiment, the braking feel simulator device 1 comprises a second hydraulic duct 18 which fluidically connects the reservoir 4 to the absorber 5.

The second hydraulic duct 18 is distinct from the first hydraulic duct 6.

Advantageously, the second hydraulic duct 18 is configured to allow faster return of the hydraulic fluid from the reservoir 4 to the absorber 5 following the release of the actuation of the braking feel simulator device 1.

According to an embodiment, the second hydraulic duct 18 comprises a check valve 19 interposed between the reservoir 4 and the absorber 5.

The check valve 19 is configured to allow a flow of hydraulic fluid from the reservoir 4 to the absorber 5, and prevent a flow of hydraulic fluid from the absorber 5 to the reservoir 4.

Therefore, during the actuation of the braking feel simulator device 1, the absorber 5 pushes the hydraulic fluid toward the reservoir 4, through the first hydraulic duct 6 and the calibrated gap 7, which implements a damping of the hydraulic fluid flow. The check valve 19 ensures that hydraulic fluid flow from the absorber 5 to the reservoir 4 flows only through the first hydraulic duct 6. Conversely, upon release of the braking feel simulator device 1, the hydraulic fluid flows out toward the absorber 5 more rapidly, because it flows out through both the first hydraulic duct 6 and the second hydraulic duct 18.

According to an embodiment, the second hydraulic 18 extends parallel to the first hydraulic duct 6.

Advantageously, such a configuration reduces the overall volume of the braking feel simulator device 1.

According to an embodiment, the absorber 5 comprises a thrust shaft 22. The thrust shaft 22 is configured to be biased against the at least one elastic element 16 in response to an actuation of the brake pedal 3.

The thrust shaft 22 is positioned inside the housing compartment 15.

According to an embodiment, the thrust shaft 22 is configured to be biased by the brake pedal 3 in translation along the actuation axis 8 against the at least one spring element 16. The absorber 5 thus applies a counteracting force on the actuation of the brake pedal 3.

According to an embodiment, the braking feel simulator device 1 comprises at least one sensor 21.

The at least one sensor 21 is configured to detect an actuation and/or a movement of the braking feel simulator device 1.

According to an embodiment, the at least one sensor 21 is configured to detect the movement of at least one component of the braking feel simulator device 1.

According to an embodiment, the at least a sensor 21 is configured to detect a movement of the thrust shaft 22 within the absorber 5.

Preferably, the at least one sensor 21 is configured to detect a translation of the thrust shaft 22 along the actuation axis 8.

Advantageously, such a translation of the thrust shaft 22, actuatable by the brake pedal 3, can be correlated with the movement of the brake pedal 3 by a driver. The movement of the brake pedal 3 is usable to determine the braking force required by a driver from the braking system 2.

According to an embodiment, the at least one sensor 21 is either a position sensor or a pressure sensor or a force sensor or a combination thereof.

According to an embodiment, the at least one sensor 21 is a laser position sensor or an infrared position sensor or an elastomeric sensor or a piezoelectric sensor or a Hall effect sensor or a magnetoresistive sensor or a linear magnetic sensor or a combination thereof.

According to an embodiment, the at least one sensor 21 is positioned inside the absorber 5. Preferably, the at least one sensor 21 is positioned inside the housing compartment 15.

According to an embodiment, the at least one sensor 21 is positioned connected to the thrust shaft 22.

According to a further aspect of the invention, a braking system 2 comprises a braking feel simulator device 1 as described above.

Moreover, the braking system 2 comprises a brake pedal 3 operatively connected to the braking feel simulator device 1.

According to an embodiment, the brake pedal 3 is connected to the absorber 5 so that an actuation of the brake pedal 3 corresponds to a pressurization of the hydraulic fluid contained in the absorber 5, which conveys a flow of hydraulic fluid from the absorber 5 toward the reservoir 4, through the first hydraulic duct 6.

According to an embodiment, the brake pedal 3 is connected to the absorber 5 by means of a mechanical connection 20, preferably by means of an articulated connection.

An actuating force applied by a driver on the brake pedal 3 is thus mechanically transferred to the absorber 5.

Advantageously, the connection between brake pedal 3 and absorber 5 is without a hydraulic connection.

Specifically, the braking system 2 described above is configured so that an actuation of the brake pedal 3 by a driver corresponds to a reaction force applied by the braking feel simulator device 1 on the brake pedal 3 against an actuation of the brake pedal 3.

The reaction force applied by the braking feel simulator device 1 on the brake pedal 3 against an actuation of the brake pedal 3 is implemented by the combined counteracting action of the absorber 5 and the calibrated orifice 7.

The absorber 5 is configured to generate a reaction force against an actuation of the brake pedal 3, e.g., by means of the at least one elastic element 16 configured to counteract the actuation of the brake pedal 3.

The calibrated orifice 7 is configured to generate a damping force on the hydraulic fluid conveyed from the absorber 5 to the reservoir 4 through the first hydraulic duct 6, under the actuation of the brake pedal 3, and such a damping force counteracts the actuation of the brake pedal 3.

The combined counteracting action of the absorber 5 and the calibrated orifice 7 is configured to simulate the feel and stiffness of a brake pedal or lever of the conventional hydraulic braking systems.

When the brake pedal 3 is released, the hydraulic fluid previously conveyed from the absorber 5 to the reservoir 4 flows out from the reservoir 4 to the absorber 5 passing through the first hydraulic duct 6, and possibly also through the second hydraulic duct 18.

According to an embodiment, the braking system 2 comprises an electronic processing unit.

Moreover, the braking system 2 comprises at least one brake caliper.

The electronic processing unit is electrically connected to the braking feel simulator device 1 and to at least one brake caliper.

The electronic processing unit is configured to actuate the at least one brake caliper upon detection, by the at least one sensor 21, of an actuation and/or movement of the braking feel simulator device 1.

Obviously, those skilled in the art will be able to make changes or adaptations to the present invention, without however departing from the scope of the following claims.

### List of Reference Numerals

1. Braking feel simulator device
2. Braking system
3. Brake pedal
4. Reservoir
5. Absorber
6. First hydraulic duct
7. Calibrated orifice
8. Actuation axis
9. First absorber end
10. Second absorber end
11. Containing wall
12. Bottom wall
13. Tank compartment
14. Perimeter wall
15. Housing compartment
16. Elastic element
17. Cap
18. Second hydraulic duct
19. Check valve
20. Mechanical connection
21. Sensor
22. Thrust shaft

In the Claims:

1-13. (canceled)

14. A braking system, comprising a braking feel simulator device and a brake pedal operatively connected to the braking feel simulator device,
said braking feel simulator device comprising:
a reservoir configured to contain a hydraulic fluid; and
an absorber configured to apply a reaction force on the brake pedal to contrast an actuation of the brake pedal,
wherein the reservoir and the absorber are fluidically connected directly to each other by a first hydraulic duct,
wherein the first hydraulic duct comprises a calibrated orifice interposed between the reservoir and the absorber, and
wherein the brake pedal is connected to the absorber through an articulated mechanical connection, so that an actuating force applied by a driver on the brake pedal is transferred mechanically to the absorber.

15. The braking system of claim 14, wherein the braking system is configured to contain the hydraulic fluid, with fluid continuity, inside the absorber and the reservoir.

16. The braking system of claim 14, wherein the absorber extends along an actuation axis, between a first absorber end and an opposite second absorber end,
wherein the first hydraulic duct extends along a direction substantially transverse to the actuation axis, and
wherein the absorber is configured to be connectable to the brake pedal and is configured so that at the actuation of the brake pedal corresponds a pressurization of the hydraulic fluid contained in the absorber, which conveys a flow of the hydraulic fluid from the absorber to the reservoir, through the first hydraulic duct.

17. The braking system of claim 16, wherein the absorber comprises a perimeter wall extended in a direction parallel to the actuation axis, between the first absorber end and the second absorber end,
wherein the perimeter wall defines therein a housing compartment configured to contain the hydraulic fluid,
wherein the reservoir comprises a containing wall and a bottom wall substantially transverse to the containing wall, the bottom wall and the containing wall forming a reservoir compartment configured to contain the hydraulic fluid,
wherein the first hydraulic duct extends through the bottom wall of the reservoir and the perimeter wall of the absorber, so that the first hydraulic duct fluidically connects the reservoir compartment to the housing compartment, and
wherein the braking system further comprises at least one of the following features:
the reservoir is fixed to the absorber;
the reservoir is made in one piece with the absorber;
the bottom wall extends in a plane substantially parallel to the actuation axis and the containing wall is substantially transverse to the actuation axis;
the reservoir is at least partially interpenetrated with the absorber;
the reservoir is distinct from the absorber.

18. The braking system of claim 14, wherein the calibrated orifice forms a section with a diameter comprised between 0.7 mm and 1.5 mm.

19. The braking system of claim 14, wherein a length of the calibrated orifice is less than 3.0 mm.

20. The braking system of claim 14, wherein a length of the first hydraulic duct is less than 10.0 mm.

21. The braking system of claim 14, wherein the absorber comprises a perimeter wall extended along an actuation axis which defines a housing compartment therein,
wherein the absorber comprises at least one elastic element positioned within the housing compartment and configured to be biased along a direction substantially parallel to the actuation axis, and
wherein, in an operating configuration, the at least one elastic element is immersed in the hydraulic fluid.

22. The braking system of claim 21, wherein the absorber comprises a plurality of elastic elements positioned in series and/or in parallel within the housing compartment, and wherein the elastic elements comprise compression coil springs positioned coaxial to the actuation axis and/or at least one of conical spring washers, square springs, torsion springs, strip springs, shaped springs.

23. The braking system of claim 14, further comprising a second hydraulic duct fluidically connecting the reservoir to the absorber, and wherein the second hydraulic duct is distinct from the first hydraulic duct.

24. The braking system of claim 23, wherein the second hydraulic duct extends parallel to the first hydraulic duct.

25. The braking system of claim 23, wherein the second hydraulic duct comprises a check valve interposed between the reservoir and the absorber, and wherein the check valve is configured to allow a flow of hydraulic fluid from the reservoir to the absorber, and prevent a flow of the hydraulic fluid from the absorber to the reservoir.

26. The braking system of claim 14, further comprising at least one sensor configured to detect an actuation and/or a movement of the braking feel simulator device.

27. The braking system of claim 26, wherein the at least one sensor is either a position sensor or a pressure sensor or a force sensor or a combination thereof.

28. The braking system of claim 26, wherein the at least one sensor is a laser position sensor or an infrared position sensor or an elastomeric sensor or a piezoelectric sensor or a Hall effect sensor or a magnetoresistive sensor or a linear magnetic sensor or a combination thereof.

29. The braking system of claim 26, wherein the at least one sensor is placed inside the absorber.

30. The braking system of claim 21, wherein the braking system further comprises at least one sensor configured to detect an actuation and/or a movement of the braking feel simulator device, wherein the absorber comprises a thrust shaft configured to be biased against the at least one elastic element in response to the actuation of the brake pedal, and wherein the at least one sensor is configured to detect a movement of the thrust shaft inside the absorber.

31. The braking system of claim 15, wherein the brake pedal is connected to the absorber so that at the actuation of the brake pedal corresponds a pressurization of the hydraulic fluid contained in the absorber, which conveys a flow of the hydraulic fluid from the absorber to the reservoir through the first hydraulic duct.

32. The braking system of claim 26, further comprising an electronic processing unit and at least one brake caliper, wherein the electronic processing unit is electrically connected to the at least one brake caliper and to the braking feel simulator device, and wherein the electronic processing unit is configured to actuate the at least one brake caliper upon detection by the at least one sensor of the actuation and/or the movement of the braking feel simulator device.
